(19) United States
(12) Patent Application Publication
(10) Pub. No.: US 2007/0194477 A1
(43) Pub. Date: Aug. 23, 2007

(54) Feather-based lining product, method of preparation and installation for implementation of the method

(75) Inventors: Christophe Gaignard, Petosse (FR); Anne Darcourt-Lezat, Lucon (FR)

Correspondence Address: YOUNG & THOMPSON, 745 SOUTH 23RD STREET, 2ND FLOOR, ARLINGTON, VA, 22202, US

(73) Assignee: NAP' TURAL, SAINTE HERMINE (FR)

(21) Appl. No.: 11/785,295

(22) Filed: Apr. 17, 2007

Related U.S. Application Data
(62) Division of application No. 10/475,977, filed on Oct. 27, 2003.

(30) Foreign Application Priority Data
Apr. 26, 2001 (FR) 01/015594

(51) Int. Cl. B32B 37/00

(52) U.S. Cl. 264/123; 156/308.2; 425/110

(57) ABSTRACT

The feather-based padding product has a coherent form due to the presence of a structure in the form of a three-dimensional network; this network consists of thermoplastic fibres (2) mutually bound, which trap the feathers. These fibres (2) are first mixed with the feathers, then, with appropriate thermal treatment, these fibres are bonded at their contact points (5). The padding product is thus in the form of a web and it is conditioned as a roll or in the form of slabs.

### BACKGROUND OF THE INVENTION

This invention concerns a padding product whereof the basic material consists of feather; it also concerns the method of preparation of such product and the installation for the implementation of the method.

### DESCRIPTION OF THE RELATED ART

Feather-based padding products find their application in numerous industries because of their properties and qualities.

They can be found in the bedding industry, furniture, clothing, but they can also be used for padding and/or thermal insulation in other fields.

This material consists of feathers, but it consists generally of feathers, feather quality items, small feathers and/or downs according to the usages. It is normally available in bulk and its implementation is rather awkward. It has indeed characteristics close to those of light pulverulent materials, i.e. it is formless and it is quite volatile.

It has already been suggested, as described in the documents WO-92 06916 and WO-00 56971, to master this raw material in order to improve the conditions of its implementation.

In these documents, it is contemplated to confer it cohesion while profiling said material in the form of panels or laps by means of a method consisting in gluing the downs either by a chemical reaction or by means of an agent sprayed on the material.

Another document, JP-61-213087, suggests a structure in the form of a leaf wherein downs, small feathers or feathers are interwoven with animal fibre and are made integral by melting an integral synthetic fibre into the mixture.

In the latter document, the low melting point synthetic fibre is mixed to the padding product to enable fastening by gluing the downs, small feathers and/or feathers, on the animal fibre which is longer.

This invention propose a padding product, based on feather, small feathers and/or downs which also exhibits a certain coherence, available for instance in the form of plates or rolls.

But this product, with respect to the products described in the documents mentioned above, has the advantage of preserving the properties inherent to feathers and to downs, i.e. their thermal power, their inflating property and their feel generally speaking.

### SUMMARY OF THE INVENTION

The invention promotes this product and makes it useable in domains where high thermal insulation and comfort quality is sought as in furniture, bedding, car seats for instance.

This product according to the invention is notably recognisable by the means which enable to confer to said product a form and a volume, better suited to its destination and especially to its implementation in the different industries for which it is intended.

According to the invention, this padding product consists essentially of feathers and of a supple structure, coherent, in a three-dimensional network, which retains and traps said feathers, which structure consists of appropriate thermoplastic fibres which are interwoven and bound together, and this product is derived from a preparation method detailed below which consists, in a first step, in preparing the fibres by processing forming then in realising this intimate mixture, by mechanical processing of said fibres and feathers i.e. of both these products of so different natures, which mixture is then worked into the form of a web then processed thermally before bonding and/or gluing the fibres together.

According to a preferred arrangement, the fibres forming this structure consist of two-component fibres: the component forming the core is a synthetic fibre made of material such as a polymer stable at high temperature, i.e. having a high softening point, above the temperature of the thermal treatment of the mixture, i.e. 200° C. for instance, the other component at the surface of the fibre, forming a sheath, is made of a material such as a polymer whereof the softening temperature is lower than that of the core, ranging for instance between 70 and 180° C., enabling to provide thanks to said thermal treatment, a true bonding at a contact point of two of these structural fibres.

Still according to the invention, the length of the structural fibres ranges between 20 and 100 mm with a titration of 1 to 25 dtex for instance.

The properties of this basic padding product, i.e. comprising simply a mixture of feathers and of structural fibres, can also be modified by the adjunction of complementary fibres. Thus, according to the invention the product may comprise in addition, so-called volume fibres, which exhibit for instance a curling, preferably a substantially helical shape, which fibres are either natural, artificial or synthetic whereof the temperature at which the state may change by degradation or by softening is higher than the temperature of the bonding of the structural fibres, i.e. a temperature close to or greater than that of the core of the structural fibres.

The adjunction of volume fibres, i.e. of curled fibres, improves the inflating character of the product, i.e. its propension to occupy and to keep a certain volume. Their presence also exhibits the advantage of improving the cohesion of the product since they may also be glued to the structural fibres.

The product according to the invention may still contain other constituents with one or several particular functionalities of the anti-bacterial, anti-acarian, flame retardant type. These constituents may be the volume fibres especially processed or any other complementary fibre or still feathers or added particles.

Still according to the invention, the padding product consists of feathers, i.e. feathers, small feathers, downs, in a proportion ranging between 10 and 80% in weight, preferably of the order of 30 to 60% and the complement consists of structural fibres and/or of mixture of structural fibres and of complementary fibres, volume fibres or other constituents, in which complement the structural fibres have a proportion which is for instance of the order of 10 to 100% in weight.

The padding product according to the invention is preferably worked into the form of web and this web may possibly be covered over one of its faces or be completely enveloped, by means of a coating made of the material of non-woven type or a sprayed-on film, which coating may also be of thermomeltable type and it is preferably applied before the thermal treatment operation of the web in order to be bonded and/or glued to the structural fibres, notably.

This coating promotes the retention of the feathers and reduces leaks, during the-cutting operations of the web, in the vicinity of the cutting zone.

The invention also concerns the general preparation method of the padding product detailed above. This method consists—in preparing an intimate and homogeneous mixture comprising feathers, i.e. feathers, small feathers, downs and free fibres made of at least so-called structural fibres,—in conforming this mixture in the form of a web and,—in performing a thermal treatment with hot air, at appropriate temperature, sufficient to web said structural fibres wherever they are in contact to one another and,—in cooling down the web and its structure gradually, before conditioning.

Still according to the invention, the preparation of the mixture of feathers and of fibres consists, in a first step, in applying successively on an endless conveyor belt, a suitable quantity of fibres then of feathers, and in subjecting this sandwich, to at least one processing forming operation which enables intimate and homogeneous mixing of the feathers and fibres before making the lap.

Still according to the invention, before mixing with the feathers, the fibres are subject to a prior processing forming operation, regardless whether structural fibres on their own or an assembly formed of said structural fibres, of complementary fibres, such as the volume fibres or other constituents having particular functionality, which fibres and constituents, as the case may be, are distributed by superimposed layers, on an endless conveyor belt, in the form of a sandwich, before being subject to at least one processing forming operation.

The method may also consist, before thermal treatment of the web, in protecting and enveloping said web by means of a coating in the form of non-woven fabric or in the form of spayed-on film or thin layer which coating made for instance of a material such as a thermoplastic polymer, may also be capable of binding by thermal softening with the structural fibres.

The invention concerns also the installation for the implementation of the method detailed previously. This installation comprises a storage cell for the padding material, i.e. feathers, small feathers and downs and, at least a supply or storage cell for pre-processed fibres, which cells are provided to deposit on a endless conveyor belt, a layer of fibres then a layer of feathers, which conveyor belt is arranged upstream of a so-called pre-processing forming machine which realises intimate and homogeneous mixture composed of feathers and of free fibres, which installation comprises, after said pre-processing forming machine, a napper and, behind this napper, a facility for thermal treatment which enables to realise the welding operation of the structural fibres at each of their contact points.

The installation may contain between the pre-processing forming machine and the napper, one or several so-called pre-processing forming machines, which improve still the quality of the feathers-fibres mixture, which mixture is then sent to a hopper connected to said napper.

The installation comprises also, to suit the requirements, at least one so-called pre-processing forming machine for the fibres and other possible constituents, which pre-processing forming machine is fed by an endless conveyor belt, which conveyor belt circulates beneath one or several cells wherein are stored the fibres i.e. the structural fibres and, possibly, the complementary fibres i.e. the volume fibres and the other constituents or fibres having for instance particular functionality, which fibres are arranged in layers on said endless conveyor belt and the sandwich thus prepared is subject to pre-processing forming before being mixed with the feathers.

The installation contains a napper of volumetric chimney type and may possibly be followed with a second napper of pneumatic type for instance, which pneumatic napper comforts and reinforces the random distribution of the structural fibres and multiplies the contact points of said fibres between one another, while disturbing their arrangement in the mass of the mixture in the form of lap, which provides said lap with identical resistance to deformation in all directions.

The installation also contains means which enable to associate a superficial coating with the lap, before the thermal treatment, on one or on both faces.

### BRIEF DESCRIPTION OF THE DRAWINGS

The invention will still be detailed using the following description and appended drawings given for exemplification purposes and wherein:

FIG. 1 represents schematically a portion of the padding product according to the invention;

FIG. 2 represents a structural fibre;

FIG. 3 represents a so-called volume fibre;

FIG. 4 represents schematically a pre-processing forming machine for the fibres;

FIG. 5 represents schematically the pre-processing forming machine of the fibres-feathers mixture;

FIG. 6 represents globally and schematically the different processing and profiling steps of the fibres-feathers mixture;

FIG. 7 represents in a more detailed fashion and schematically a napper comprising a vertical napper and a pneumatic napper;

FIG. 8 represents in a more detailed fashion than FIG. 6, the thermal treatment facility of the web, followed by the conditioning station.

### DESCRIPTION OF THE PREFERRED EMBODIMENT

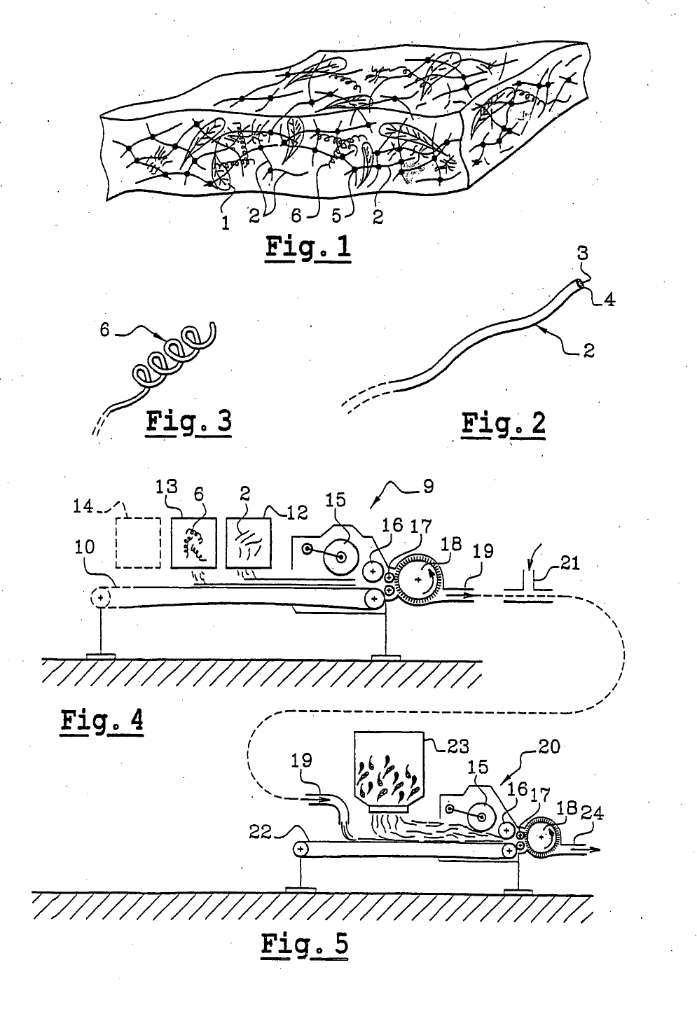

FIG. 1 shows a portion of the padding product according to the invention. This product consists mainly of feathers 1 which are trapped in a structure formed of fibres 2.

As detailed thereafter, the fibres 2 are first of all mixed with the feathers 1 and the assembly is then subject to a thermal treatment operation which will bind the structural fibres 2 together.

The word ‘feathers’ designates indifferently feathers, small feathers or downs or even a mixture of these different products. The proportion of feathers in the padding product ranges between 10 and 80% in weight, preferably of the order of 30 to 60%. The remainder, as detailed below consists notably of the structural fibres 2.

A structural fibre 2 is represented on FIG. 2. This fibre is of the two-component type. The central component or core 3 consists of a fibre made of the material of the polymer type with high softening point, above the temperature of the thermal treatment of the feathers-fibres mixtures, i.e. above 200° C. for instance. The other component, at the surface, forms for instance a sheath 4 made of the material of the polymer type also but whereof the softening temperature is smaller, for instance ranging between 70 and 180° C.; this temperature corresponds to the temperature of the thermal treatment of the feathers-fibres mixture which will be discussed below.

This particularity of the structural fibres 2, as they consist of two polymer components, enables to obtain fibre to fibre welding using one of the components while the other preserves its integrity and confers its technical characteristics to the product.

The configuration of the structural fibres 2 is preferably a core 3-sheath 4 configuration, whereas said sheath is manufactured using a (polymer) material whereof the melting temperature is lower than that of the core 3.

During thermal treatment of the fibres-feathers mixture, this core-sheath configuration of the structural fibres 2 enables said sheaths 4 to merge together at each of their contact point(s) and thus, when cooling down said mixture, as many bonding points 5 are formed and a contention structure of feathers is obtained.

The length of the structural fibres 2 is of the order of 2 to 10 cm for instance with a titration ranging between 1 and 25 dtex.

These structural fibres 2 are mixed intimately with the feathers and are distributed at random in the product, as represented on FIG. 1. Throughout the preparation phase of the feathers-fibres mixture in the form of a web, i.e. before the thermal treatment of said mixture, the structural fibres are free and taking their number into account, they are occasionally in contact with one another. They are also pressed against one another and the bonds take place during the thermal treatment. The temperature of the treatment is such that it causes, as indicated previously, a real bonding at each contact point 5 of these fibres 2 between one another, thanks first of all to their sheath 4 softening and melting, then to a hardening during the cooling phase as detailed below in connection with FIG. 8.

These multiples bonds between the structural fibres 2 form intrinsically, in the product represented on FIG. 1, a three-dimensional network which retains and traps the feathers or the mixture of feathers, forming thus a coherent product, that can be handled and profiled easily to suit the requirements.

Heating the web, then cooling it down, may cause a compacting phenomenon of the feathers and of the product obtained. The product only gains in volume after several hours, let alone several days.

This retraction during the thermal treatment, may be disturbed or reduced, let alone suppressed, by the adjunction of complementary fibres in the fibres 2-feathers 1 mixture, as represented on FIG. 1; these complementary fibres form the volume fibres 6.

These fibres 6 are for instance curled and are preferably in the form of a helicoid as illustrated on FIG. 3. Their length and titration is of the same order as the structural fibres.

These volume fibres 6 are either natural fibres or artificial or synthetic fibres. The state change temperature by degradation or by softening is above the welding temperature of the structural fibres 2.

The complementary natural fibres may be of animal origin (wool, rabbit hairs . . . ) or of vegetal origin (kapok . . . ).

The distribution of the complementary fibres in the padding product is, as for the structural fibres 2, as homogeneous as possible. They contribute to the cohesion of the product. They may wherever they are in contact with structural fibres 2 and according to their nature, be glued to said fibres when the sheath 4 of these structural fibres 2 softens.

Other constituents, non represented, may also be integrated to the padding product in relation to its destination, as for instance fibres or particles with particular functionality deriving from a flame retardant, anti-bacterial, anti-acarian treatment etc.

These treatments may also be applied to the complementary fibres, to the volume fibres 6 or to feathers or other particles.

As indicated previously, the feathers occupy 10 to 80% in weight, preferably 30 to 60%, of the padding product. The complement consists of the structural fibres 2 and, possibly, the complementary volume fibres 6 or other. In this complement, the proportion of structural fibres is of the order of 10 to 100% in weight as the case may be and the other fibres of 0 to 90%.

FIGS. 4 and 5 show schematically the sequence of the so-called pre-processing forming machines in the mixing installation of the fibres and feathers.

This installation comprises first of all, as represented on FIG. 4, a preparation station of the fibres and when using a mixture, of different sorts of fibres, then it comprises, as represented on FIG. 5, a mechanical station for mixing the fibres and the feathers.

The preparation machine of the fibres, then so-called pre-processing forming machine 9, is a conventional machine of the type of those used in the domain of preparation of fibres for non-woven fabric.

The fibres, generally speaking, are delivered compacted. The pre-processing forming machine 9 enables to decompact the structural fibres 2 and, as the case may be, the volume fibres 6 and, possibly, other fibres or complementary constituents, while performing a suitable mixture.

The pre-processing forming machine 9 is fed by an endless conveyor belt 10 provided beneath one or several cells or hoppers. A first cell 12 contains structural fibres 2. This cell 12 is preceded by a cell 13 which contains the volume fibres 6 and one may find other complementary cells 14 wherein are stored fibres or other constituents with various functionalities as indicated previously.

Each type of fibres as the case may be, is deposited on the conveyor belt 10 and the layer(s) forming a sandwich, are introduced in the pre-processing forming machine while passing first of all beneath a compacting drum 15, then beneath a driving roll 16 situated above the end of the conveyor belt 10. Then the sandwich is driven by a pair of rolls 17 and it is shown to a spiked pulling roller 18 which sends the fibres through the output 19 towards the pre-processing forming machine 20 of the following station.

It is also possible to connect a conduit 21 on the output 19 to introduce in the circuit materials to be recycled such as for instance of the raw material or waste collected from the production line or even to introduce waste returned from customers.

This prior separate preparation of the fibres is an important step of the method; it provides a better result as regards the mixture then performed between the feathers and said fibres.

The pre-processing forming machine 20, FIG. 5, is similar to that of FIG. 4. It is also fed by a conveyor belt 22 which receives on the one hand the fibres coming from the output 19 of the pre-processing forming machine 9, and, on the other hand, the feathers or mixtures of feathers provided in a cell 23 situated downstream of said output 19.

The fibres and feathers are dosed and are deposited on the conveyor belt 22. The conveyor belt 22 receives first of all a layer of fibres which form a thickness of 5 to 15 cm for instance, then a layer of feathers whereof the thickness may reach 50 to 60 cm. This sandwich is introduced by the conveyor belt 22 in the pre-processing forming machine 20. A drum 15 situated at the input, performs first compacting of the layers. It is followed with a roll 16 which also presses the sandwich, which roll 16 is arranged above the end of the conveyor belt 22. Then the layers pass between a pair of feeding rolls 17 which present the sandwich to the spiked pulling roller 18.

The feathers and fibres are mixed intimately in a homogeneous fashion and sent through the output 24 either another pre-processing forming machine, non-represented, or towards the napper.

The fibres and feathers transit from one machine to the other by suction effect and the suction waste is re-injected into the circuit and recycled through the conduit 21.

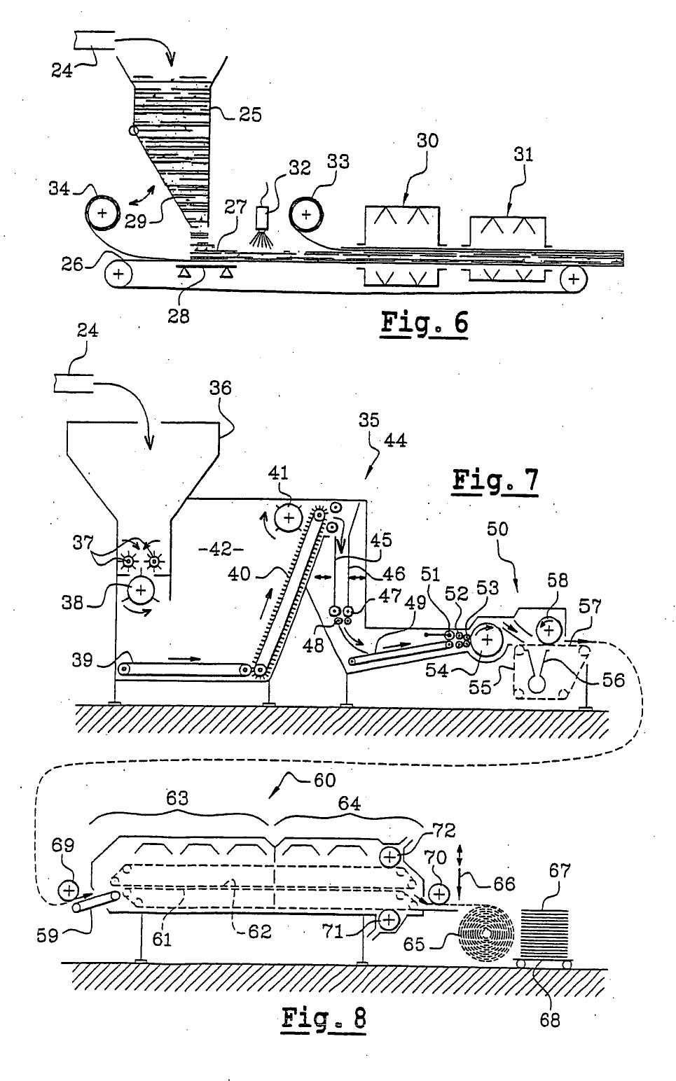

FIG. 6 illustrates, in the form of a simple functional diagram, the treatment and the profiling of the fibres-feathers mixture, to lead to the product suggested by the invention i.e. a lap which may be handled and for instance be conditioned in the form of a roll.

The fibres-feathers mixture arrives from the output 24 of the pre-processing forming machine 20 and it is placed in a buffer cell 25. This cell 25 is arranged above a conveyor belt 26, which conveyor belt receives a layer of the mixture consisting of fibres and feathers. This layer is deposited in the form of a web 27. A continuous weighing system, by means of scales 28 arranged under the upper side of the conveyor belt 26, enables to adjust the thickness of the web 27. The cell 25 may contain a mobile wall 29 in the form of an adjustable batten, to modify the flow rate of the mixture, i.e. the quantity of fibres and feathers deposited on the conveyor belt 26.

The cell 25 acts as a napper on the diagram of FIG. 6. The actual napper will be detailed below, on FIG. 7.

After the cell 25 which acts as a napper, one finds the thermal treatment installation of the feathers-fibres mixture, deposited in the form of a web on the conveyor belt 26.

The thermal treatment installation comprises first of all a casing 30 for heating then a casing 31 for cooling.

The casing 30 for heating the mixture enables to raise the core temperature to a sufficient value to soften, melt and weld the structural fibres 2, at all their contact points between one another.

Heating is performed for instance by circulating hot air through the casing 30. The fibres-feathers mixture circulates through the casing 30 at a speed suitable for the result expected.

The casing 31 for cooling enables to consolidate the bonding points of the structural fibres 2 and possibly the gluing points between said fibres and the complementary fibres such as the volume fibres 6.

Cooling is performed for instance by circulating fresh air.

Still on FIG. 6, means enable to apply a simple coating on the web 27 freshly formed, or to envelope said lap before thermal treatment.

A spray nozzle 32 enables for instance to apply on the surface a product which forms a superficial coating in the form of a film or of a thin gluing film.

This coating may also consist of a material of non-woven type or of a film stored on a roll 33 to be deposited on the web 27 downstream of the cell 25. Another roll 34 situated upstream of said cell may place this coating under the web, between said web and the conveyor belt 26.

By using a thermomeltable coating, this said coating may be glued or welded to the structural fibres 2 during the thermal treatment.

At the output of the casing 32, the web 27 forms an actual manufactured product that can be conditioned in the form of a roll, capable of being worked more easily than bulk feathers.

FIG. 7 represents, still schematically, but in a more detailed fashion, a napper 35 which receives, from the output 24 of the pre-processing forming machine 20, the fibres and feathers mixture.

This fibres-feathers mixture is transported and sent by a suction effect to a hopper 36 which is part of the napper. This hopper 36 carries, at its lower end, a couple of rotors 37 acting as extractors, followed by an rotor 38 which sprays the mixture onto a conveyor belt 39 situated at the lower section of the napper.

This conveyor belt 39, which is horizontal, feeds a second conveyor belt 40 which forms a kind of lift conveyor belt fitted with hooking members to drive the fibres and feathers towards the napper properly speaking, detailed thereafter.

This lift conveyor belt 40 is connected at its upper section to a rotor 41 which equalises the layer brought by said conveyor belt and recycles the fibres and feathers towards the inside of the caisson 42 of the napper, i.e. in the section situated above the supply conveyor belt 39.

The lift conveyor belt 40 sends the feathers and fibres to the napper properly speaking, which comprises a volumetric chimney 44 consisting of two vertical and parallel plates 45, 46 arranged opposite one another; one of the walls is vibrating and the other is situated at an adjustable distance from the first. The fibres and feathers are packed in the chimney 44 and this mixture takes the form of a web.

This mixture in the form of web progresses by simple gravity and reaches a driving and compacting assembly consisting of two couples of rolls 47 and 48. These rolls 47 and 48 propel the mixture towards a conveyor belt 49, which conveyor belt 49 feeds a second napper, so-called pneumatic napper 50.

This pneumatic napper 50 comprises, at the end of the conveyor belt 49, a presser drum 51 followed by a pair of couples of driving rolls 52 and 53 which feed a roller 54. This roller 54 enables to re-calibrate the web which comes from the first napper. It evolves at a speed which is adjusted in relation to the forward speed of the transport conveyor belt 49.

The roller 54 drives the web on a punched conveyor belt 55 which is in the form of an endless band rotating round a suction system 56. The web is thus pressed against the active side 57 of the punched conveyor belt 55 and it is additionally calibrated by means of a roller 58 situated downstream of the suction zone, above the active side 57.

The suction device 56 enables to shake the mixture and to promote disorientation of the fibres, notably structural fibres 2, in the thickness of the web.

This random distribution of the structural fibres confers to the finished product a resistance to elongation which is comparable regardless of the direction of the load that is applied to said product.

At the output of the pneumatic napper 50, the web is inserted by means of a conveyor belt 59, into the thermal treatment station 60.

This station 60 comprises two conveyor belts which extend from the input to the output:—a lower endless conveyor belt 61 and—an upper endless conveyor belt 62. The web is guided between both these conveyor belts which enable to compress the mixture and to drive said mixture throughout the whole treatment which takes place first of all with hot air to raise the lap to a suitable temperature, then with cold air.

The station comprises therefore two zones: a zone 63 which extends from the input for raising the temperature of the web, followed by a zone 64 for cooling the web.

The speed of the web in the furnace may be two m/mn for instance and the total duration of the treatment is of the order of two to three minutes approximately.

The duration of the thermal treatment is established in relation to the thickness of the web to obtain homogeneous and sufficient temperature at the core of the mixture, in order to soften the sheaths 4 of the structural fibres 2, then to melt and bound each contact point between the fibres 2, with consolidation of these contact points as the cooling progresses.

The temperature in the zone 63 is selected in relation to the characteristics of the structural fibres 2; it is for instance of the order of 140° C.

At the output of the station 60, the web is conditioned in the form of a roll 65 or it is cut off by means of a knife 66 and stored in the form of a plate 67 on a cart 68. The width of the web, according to the installation, may be of the order of 2 m or more to suit the requirements.

Before insertion into the furnace, the lap may also be subject to a dressing operation, i.e. receive a coating of non-woven type or in the form of a sprayed-on film, as detailed above with FIG. 6.

This coating, for instance of a thermoplastic material, may also have a softening point close to that of the envelope 3 of the structural fibres 2 and, in this case, be welded or glued to said structural fibres during the thermal treatment of the web.

To obtain good calibration of the web, as shown on FIG. 8, disks 69 may be positioned on the conveyor belt 59 at the input of the thermal treatment station 60, in order to cut the selvedges at the input. Similarly, disk knives 70 may be arranged at the output of the thermal treatment station to cut the selvedges of the lap once more in order to calibrate its width.

Still on FIG. 8, brushes enable to clean the endless conveyor belts 61 and 62.

A brush 71 is provided at the end of the lower conveyor belt 61 and a brush 72 is provided similarly at the end of the upper conveyor belt 62.

The waste from the cutting disks 69, 70 of the selvedges and that coming from the brushes 71 and 72, are re-injected into the circuit, upstream of the pre-processing forming machine 20 by means of the conduit 21 as indicated previously.

1. A method of preparation of a padding product comprising feathers and free fibres, comprising the steps of:
preparing an intimate and homogeneous mixture comprising feathers and free fibres composed at least of thermoplastic structural fibres, so-called thermoplastic structural fibres, said thermoplastic structural fibres being entangled and distributed at random so as to have contact points with each other;
working this mixture into the form of a web or a lap;
performing a thermal treatment with hot air at a suitable temperature on said web or lap, sufficient to bound said thermoplastic structural fibres wherever they are in contact to one another to form a supple and coherent structure as a three-dimensional network, said feather being retained and trapped in a homogenous manner into said three-dimensional network; and
cooling the web (or lap) and its structure gradually, before conditioning.

2. A method of preparation of the padding product according to claim 1, wherein,
the thermoplastic structural fibres (2) are of the two-component type: a component forming a core (3) made of a material of polymer type with high softening point, and an associated component, forming a sheath (4), made of a material of polymer type whereof the softening temperature is lower than that of the core (3), which
sheath enables thanks to a suitable thermal treatment, to weld these structural fibres together, at each of their contact points.

3. A method of preparation of the padding product according to claim 1, wherein,
the length of the thermoplastic structural fibres (2) ranges between 20 and 100 mm, with a titration of 1 to 25 dtex.

4. A method of preparation of the padding product according to claim 1, comprising fibres (6) acting as volume fibres and exhibiting a curling, which fibres are made of the material whereof the softening temperature is close to or greater than that of the core (3) of the thermoplastic structural fibres (2).

5. A method of preparation of the padding product according to claim 1, comprising complementary fibres or constituents fitted with one or several particular functionalities of anti-bacterial, anti-acarian, flame retardant type.

6. A method of preparation of the padding product according to claim 1, comprising feathers in a proportion ranging between 10 and 80% in weight and the complement consists structural fibers (2) and/or of a mixture of structural fibers and of complementary fibres (volume fibres (6) or other constituents), in which complement said structural fibres (2) have a proportion which is of the order of 10 to 100% in weight.

7. A method of preparation of the padding product according to claim 1, wherein,
the preparation of the mixture of feathers and of fibres comprises, in a first step, in depositing successively, on an endless conveyor belt (22), a suitable quantity of fibres, than of feathers, and in subjecting this sandwich to at least a processing forming (or opening) operation which enables to mix intimately and in a homogeneous fashion, feathers and fibres before making the web (or lap).

8. A method of preparation of the padding product according to claim 7, wherein,
the fibres are subject to a prior processing forming (or opening) operation, regardless whether structural fibres (2) on their own or an assembly composed of said structural fibres and of complementary fibres such as volume fibres (6) or other constituents having a particular functionality, which fibres and constituents as the case may be, are distributed by layers superimposed on an endless conveyor belt (10) forming a sandwich, which sandwich is subject to at least a processing forming (or opening) operation.

9. A method of preparation of the padding product according to claim 1, wherein,
before the thermal treatment operation of the web (or lap), in protecting and enveloping said web by means of a coating in the form of non-woven fabric or by
means of a sprayed-on film, which coating made of the thermoplastic material, may be bound by thermal softening with the structural fibres.

10. An installation for the implementation of the method of preparation of the padding product according to claim 1, comprising a cell or hopper (23) for storing the padding material, i.e. feathers (1), and at least a cell or amount increased (19) of fibres containing at least structural fibres (2) after pre-forming processing, which cell (23) and amount increased (19) are provided to deposit on an endless conveyor belt (22) a layer of fibres then a layer of feathers, which conveyor belt (22) is arranged upstream of a pre-processing forming machine (20) which performs an intimate and homogeneous mixture composed of feathers and of free fibres, which installation comprises, after said pre-processing forming machine (20), at least a napper and behind this napper, a station to realise the thermal treatment of the mixture in the form of web, i.e. to bind the structural fibres (2) together at each of their contact points.

11. An installation according to claim 10, comprising at least a pre-processing forming machine (9) located upstream of the pre-processing forming machine (20), which pre-processing forming machine (9) is fed by an endless conveyor belt (10), which conveyor belt circulates under one or several cells (12, 13, 14), wherein are stored the fibres, which fibres are deposited by layers on said conveyor belt (10).

12. An installation according to claim 10, comprising a first napper (35) of the vertical corridor type followed by a second napper (50) of the pneumatic type.

13. An installation according to claim 10, comprising means to deposit a coating, on the web (27), at the output of the napper, which coating, made of thermoplastic material for instance, may be glued or bonded to the structural fibres (2).

14. A method of preparation of the padding product according to claim 2, wherein the thermoplastic structural fibres (2) are of the two-component type: a component forming a core (3) made of a material of polymer type with high softening point above to 200° C., and an associated component, forming a sheath (4), made of a material of polymer type whereof the softening temperature is lower than that of the core (3), ranging between 70 and 180° C., which sheath enables thanks to a suitable thermal treatment, to weld these structural fibres together, at each of their contact points.

15. A method of preparation of the padding product according to claim 14, wherein, the suitable thermal treatment, to weld these structural fibres together, at each of their contact points, is about 140° C.

16. A method of preparation of the padding product according to claim 1, comprising feathers in a proportion ranging between 30 and 60% in weight and the complement comprises at least one of structural fibers (2) and a mixture of structural fibers and of complementary fibres (volume fibres (6) or other constituents), in which complement said structural fibres (2) have a proportion which is of the order of 10 to 100% in weight.
